(19) United States
(12) Patent Application Publication
(10) Pub. No.: US 2025/0280261 A1
(43) Pub. Date: Sep. 4, 2025

(54) METHOD, SYSTEM AND BASE STATION FOR CHARACTERIZING CELLULAR DEVICES

(71) Applicant: BULL SAS, LES-CLAYES-SOUS-BOIS (FR)

(72) Inventor: Philippe CHARTON, AIX-EN-PROVENCE (FR)

(73) Assignee: BULL SAS, LES-CLAYES-SOUS-BOIS (FR)

(21) Appl. No.: 19/069,117

(22) Filed: Mar. 3, 2025

(30) Foreign Application Priority Data
Mar. 4, 2024 (EP) 24305325.3

(51) Int. Cl. H04W 4/02; H04W 36/32

(52) U.S. Cl. CPC H04W 4/023; H04W 36/32

(57) ABSTRACT

The invention relates to a method (100) for characterizing cellular devices, said method comprising the following steps for each cellular device:
allocating (106) at least one dedicated communication slot each comprising a communication time and a communication frequency; and
receiving (112), by said base station at said at least one allocated communication slot, a signal emitted by said cellular device comprising an identifier of said cellular device;

said method (100) further comprising a temporal scan of said frequency range according to a scanning plan, by equipment for locating cellular devices; characterized in that it comprises synchronization (104) of said scanning plan and of each communication slot so that the locating equipment is listening for a frequency band comprising the communication frequency of said communication slot at the communication time of said communication slot. It also relates to a system and a base station comprising means configured to implement this method.

This application claims priority to European Patent Application Number 24305325.3, filed 4 Mar. 2024, the specification of which is hereby incorporated herein by reference.

### BACKGROUND OF THE INVENTION

### Field of the Invention

At least one embodiment of the invention relates to a method for characterizing cellular devices. At least one embodiment also relates to a system and a base station comprising means configured to implement this method.

The field of the invention is typically the field of characterization of cellular transmitters, and in particular with a view to identifying and locating said cellular transmitters.

Description of the Related Art

A cellular communications base station receives connections from cellular communication devices, also called user devices or cellular device, and hereinafter referred to as “UE” (for “user equipment”), which are located in a geographical area comprising said base station. Thus, the base station can identify each cellular device, as the latter transmits its identifier to make itself known to the base station, with a view to establishing a communication channel.

In short, when a cellular device wants to connect to a base station, it first sends a connection request, for example a RACH message. In response to this connection request, a base station scheduler, also known as a UE Scheduler, hereinafter referred to as UES, allocates one or more communication slots, called link communication slots, to said cellular device, each slot comprising on the one hand a communication frequency to be used and a communication time. The cellular device then uses said link communication slot(s) to transmit its identifier and other information to the base station which in turn assigns it one or more communication channels that the cellular device can then use to request further cellular communication slots.

It is further known to use locating equipment, such as a goniometer, to locate a cellular device, and in particular to determine the direction of said cellular device, and the location thereof. Such a device listens/observes over a limited frequency band. When an entire frequency range is to be covered, for example the range of cellular communication frequencies, the locating equipment must perform a temporal scan of said frequency range, in frequency bands, sequentially in time.

In the context of cellular communication, due to the operation described hereinbefore, it often happens that the cellular device communicates with the base station using a frequency that is not included in the frequency band currently listened to by the locating equipment, particularly during link communication slots. For these reasons, the cellular device is often not detected or measured by the locating equipment.

One aim of the at least one embodiment of the invention is to solve at least one of the above-mentioned shortcomings.

Another aim of at least one embodiment of the invention is to propose a more efficient solution for characterizing cellular devices.

Another aim of the at least one embodiment of the invention is to propose a more comprehensive solution for characterizing cellular devices.

### BRIEF SUMMARY OF THE INVENTION

At least one embodiment of the invention proposes to achieve at least one of the aforementioned aims by a method for characterizing cellular devices capable of operating in a defined frequency range in common with a base station, said method comprising the following steps performed for at least one, in particular each, cellular device wishing to connect to said base station:
allocating, by a scheduler of said base station to said cellular device, at least one dedicated communication slot, each communication slot comprising a communication time and a communication frequency; and
receiving, by said base station, at said at least one allocated communication slot, a signal emitted by said cellular device comprising an identifier of said cellular device;
   said method further comprising a temporal scan, in frequency bands, of said frequency range according to a scanning plan, by equipment for locating cellular devices;
   characterized in that it comprises synchronizing said scanning plan and each communication slot so that the locating equipment is listening for a frequency band comprising the communication frequency of said communication slot at the communication time of said communication slot.

At least one embodiment of the invention therefore proposes a solution for characterizing cellular devices wherein the locating equipment is synchronized with the scheduler, also known as the UE scheduler, so that each communication slot allocated to a cellular device wishing to communicate with the base station is synchronized with the instant and the frequency band observed by the locating equipment. Consequently, when the cellular device communicates with the base station using the frequency allocated thereto by the scheduler, the locating equipment listens to a frequency band that comprises said allocated frequency: it is therefore possible for the locating equipment to locate said cellular device. Furthermore, since for each communication slot, the frequency allocated by the scheduler is for the exclusive use of said cellular device and the cellular device transmits its identifier during these communication slots, it is possible to identify said cellular device, that is to obtain the identifier thereof and to correlate said identifier with the location determined by the locating equipment. Thus, the method according to one or more embodiments of the invention allows characterization, that is identification and location, of each cellular device wishing to connect to the base station, in an efficient and comprehensive way.

“Cellular device” is understood to mean a cellular communication device. Without loss of generality, such a device can in particular be a user device, for example a cell phone or Smartphone type device or else any type of cellular modem.

“Cellular communication” is understood to mean any type of cellular communication, such as a telephone call, data upload via the cellular network, etc. According to non-limiting example embodiments, cellular communication can be communication using 3GPP standards (or other standards such as ITU, ETSI, ARIB/TTC, CCSA, ATIS, TTA) for 2G (for example) GSM/GPRS, 3G (for example UMTS), 4G (for example), 5G (for example), 6G, and future generations of cellular networks.

According to one or more embodiments, the locating equipment can be slaved to the scheduler so that the frequency band observed by said locating equipment is determined based on the at least one communication slot allocated to the cellular device.

In this case, each communication slot allocated by the scheduler is communicated to the locating equipment. The latter adjusts, in time and/or in frequency, its frequency scanning plan of the frequency range, based on said communication slot.

In at least one embodiment, the scheduler can be configured to allocate the communication slots according to a predetermined rule, to simplify the task of the locating equipment to adapt its scanning plan. For example, communication slots can be allocated by grouping them by time and frequency, that is allocating frequencies in the same frequency band at the same instant. This allows the locating equipment to observe said band at said instant and to characterize the set of cellular devices to which said slots have been allocated.

According to one or more embodiments, the scheduler can be slaved to the locating equipment so that the communication slots are determined based on the scanning plan.

As such, at least one embodiment is more simple to implement.

According to at least one embodiment, the scanning plan of the locating equipment can be communicated to the scheduler: this scanning plan indicates each frequency band observed by the locating equipment and the instant at which said frequency band is observed, as well as the duration during which said band is observed. Thus, the scheduler can allocate one or more communication slots covered by the locating equipment in time and in frequency.

The method according to one or more embodiments of the invention may further comprise a step of locating the cellular device to determine:
a direction of arrival of a signal emitted by said cellular device; and/or
a location of said cellular device.

The step of locating the cellular device is performed based on one or more signals emitted by the cellular device and picked up, by the locating equipment, during the observation step.

The determination of the direction of arrival, and/or the location, are operations known to the skilled person, for example in the field of goniometry and will therefore not be described herein for the sake of brevity.

The locating equipment can be positioned at any location, as long as the locating equipment is at a distance and in an orientation that can receive the signal(s) emitted by the cellular equipment.

According to one or more embodiments, the locating equipment can be local to the base station, and in particular located in the base station. At least one embodiment allows the invention to be easily deployed and integrated.

According to one or more embodiments, the locating equipment can be located at a distance from the base station. In this case, the method according to at least one embodiment of the invention comprises communication between the locating equipment and said base station, either directly or via at least one other piece of equipment.

At least one embodiment of the invention allows greater freedom of deployment of the locating equipment.

In one or more embodiments, the locating equipment can be stationary, for example positioned on a stationary vehicle, on a mast, or a building, etc., or any other stationary means capable of accommodating said locating equipment.

Alternatively, the locating equipment can be mobile, for example positioned on a satellite, a moving vehicle, etc. The moving vehicle can be a land vehicle, a sea vehicle, a flying vehicle, etc.

According to one or more embodiments, synchronization between the scheduler and the locating equipment can be achieved by virtue of a synchronization module in communication with on the one hand the locating equipment and on the other hand the scheduler.

In this case, the synchronization module can be in the form of equipment independent of the scheduler and of the locating equipment.

The synchronization module can be local to the scheduler and/or to the locating equipment, or remote from said scheduler and from said locating equipment.

For example, the synchronization module may comprise:
a first sub-module located on the scheduler side, and
a second sub-module located on the locating equipment side; participating in, or performing, the communication between, or the synchronization between, said scheduler and said locating equipment.

According to one or more embodiments, synchronization between the scheduler and the locating equipment can be achieved without using any other equipment. In this case, the scheduler and the locating equipment are in communication with each other and implement said synchronization, through a software and/or hardware configuration.

According to at least one of the invention, a system is proposed for characterizing cellular devices that can communicate with a base station, in a defined frequency range, said system comprising:
a base station comprising:
   a scheduler, and
   identification equipment; and
a locating equipment;
   configured to implement the method according to at least one embodiment of the invention.

According to a general definition, the system according to one or more embodiments of the invention may comprise, in terms of technical means, any, or any combination of at least two of the optional features described hereinbefore in reference to the method according to at least one embodiment of the invention and which are not mentioned herein, for the sake of brevity.

In particular, the system according to one or more embodiments of the invention can further comprise a module for synchronizing the locating equipment and the scheduler.

The synchronization module can be positioned in the base station or be remote from the base station.

The synchronization module can be positioned locally to the locating device, or be remote from said locating device.

According to one or more embodiments, the locating equipment can be remote from the base station.

Alternatively, in at least one embodiment, the locating equipment can be local to the base station, and in particular be arranged in said base station, and even more particularly be integrated into said base station.

The locating equipment can be configured to determine a direction of arrival and/or a location of one, or each, cellular device from radio frequency measurement(s).

The locating equipment can be any type of locating equipment.

For example, the locating equipment can comprise, or can consist of, a goniometer.

The base station can be part of a network of base stations, for example of a mobile operator or of a private operator.

Alternatively, in at least one embodiment, the base station can be an isolated piece of equipment whose sole purpose is to identify surrounding cellular devices.

According to one or more embodiments of the invention, a base station is proposed comprising:
at least one scheduler,
at least one identification equipment;
at least one locating equipment;
   configured to implement the method according to one or more embodiments of the invention.

According to a general definition, the base station according to at least one embodiment of the invention may comprise, in terms of technical means, any one, or any combination of at least two, of the optional features described hereinbefore with reference to the method according to one or more embodiments of the invention and which are not mentioned herein in detail for the sake of brevity.

### BRIEF DESCRIPTION OF THE DRAWINGS

Other benefits and features shall become evident upon examining the detailed description of entirely non-limiting embodiments, and from the appended drawings in which:

FIG. 1 is a schematic depiction of a non-limiting example of a method according to one or more embodiments of the invention; and

FIG. 2 is a schematic depiction of a non-limiting example of a system according to one or more embodiments of the invention.

### DETAILED DESCRIPTION OF THE INVENTION

It is clearly understood that the one or more embodiments that will be described hereafter are by no means limiting. In particular, it is possible to imagine variants of the one or more embodiments of the invention that comprise only a selection of the features disclosed hereinafter in isolation from the other features disclosed, if this selection of features is sufficient to confer a technical benefit or to differentiate the one or more embodiments of the invention with respect to the prior art. This selection comprises at least one preferably functional feature which is free of structural details, or only has a portion of the structural details if this portion alone is sufficient to confer a technical benefit or to differentiate the one or more embodiments of the invention with respect to the prior art.

In particular, all of the described variants and embodiments can be combined with each other if there is no technical obstacle to this combination.

In the figures and in the remainder of the description, the same reference has been used for the features that are common to several figures.

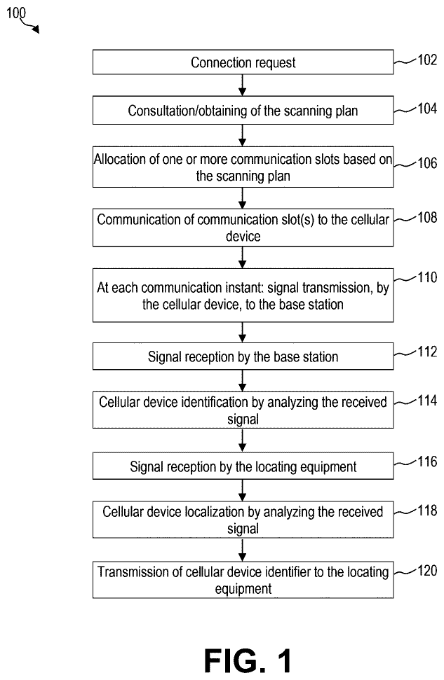

FIG. 1 is a schematic depiction of a non-limiting example of a method according to one or more embodiments of the invention.

The method 100 of FIG. 1 can be used to characterize the cellular devices located in a given geographical area, and in particular cellular devices wishing to connect to a base station.

The cellular devices can be of any type, such as for example telephones, Smartphones, SmartWatches, tablets, cellular modems, etc., and typically any cellular communication device that can connect to a base station and establish cellular communication according to any of the known or future cellular communication standards.

The method 100 comprises a step 102 in which a cellular device sends a connection request to a base station. This request allows the cellular device to signal its presence to the base station and indicating its wish to connect to the base station with a view for example to establish cellular communication.

In particular, this request can take the form of a message constructed identically for all cellular devices, with a random number selected by each cellular device.

This message is received on a dedicated channel at the base station.

In response to this request, the base station will provide the cellular device with one or more dedicated communication slots in order to carry out communication without being disturbed by other cellular communications. This allows numerous cellular devices to communicate with the base station while avoiding collisions in radio communications between said cellular devices.

In step 104, the scheduler of the base station consults a scanning plan of a cellular device locating equipment. This scanning plan indicates to the scheduler, for each frequency band observed by said locating equipment, the instant and duration during which said locating equipment observes said frequency band.

This scanning plan is communicated in advance to said scheduler, or to the base station, and stored locally. Alternatively, the scheduler obtains said scanning plan from the locating equipment or from other equipment holding said scanning plan.

In step 106, based on the scanning plan, the scheduler allocates one or more communication slots to the cellular device. Each communication slot comprises:
a communication frequency, and
a communication instant/time.
   For at least one, in particular each, communication slot, the communication frequency is selected so that at the communication instant of said communication slot said communication frequency lies within a/the frequency band observed by the locating equipment.

As mentioned above, several communication slots can have the same communication frequency: in this case, these communication slots have different communication times. In other words, these communication slots use the same communication frequency at different times.

Alternatively, or in addition, several communication slots can have the same communication time: in this case these communication slots have different communication frequencies. In other words, these communication slots use different frequencies at the same communication instant/time.

In step 108, the communication slot(s) are communicated to the cellular device.

Then, in step 110, at the communication instant or instants indicated in the communication slot or slots, the cellular device emits at least one signal to the base station, transmitting its identifier, and optionally other data, for example data indicating the nature of the cellular communication it wishes to establish.

The at least one signal emitted by the cellular device is received by the base station in step 112.

In step 114, this at least one signal is processed and the identifier of the cellular device, ID, is extracted, for example by base station identification equipment.

The cellular device is therefore identified.

In step 116, performed at the same time, or substantially at the same time, as step 112, the at least one signal emitted by the cellular device in step 110 is additionally received by the locating equipment.

This at least one signal is processed, in step 118, by the locating equipment to determine the direction of arrival of said signal, noted DoA, and/or the location of the cellular device, noted LOC, according to known techniques.

Thus, the cellular device is located.

In an optional step 120, the ID of the cellular device, determined at the base station in step 114, is communicated to the locating equipment. Thus, the locating equipment knows the identifier of the cellular device and the location thereof.

Alternatively, or in addition, the identifier ID of the cellular device, and at least one of the locating data DoA and/or LOC can be communicated to external equipment.

In the example shown in FIG. 1, the at least one communication slot is selected based on the scanning performed by the locating equipment.

According to one or more embodiments, the at least one communication slot can be freely selected by the scheduler and it is the scanning performed by the locating equipment that can be adapted to said at least one communication slot allocated to the locating equipment.

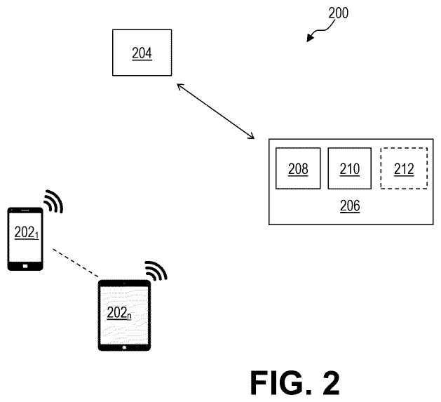

FIG. 2 is a schematic depiction of a non-limiting example of a system according to one or more embodiments of the invention.

The system 200 of FIG. 2 can be used to implement a method according to the invention, and in particular the method 100 of FIG. 1, by way of at least one embodiment.

The system 200 can be used to characterize cellular devices 202₁-202ₙ located in a given geographical area, and in particular cellular devices 202₁-202ₙ wishing to connect to a base station.

Each cellular device 202ᵢ can be of any type, such as for example a telephone, a Smartphone, a SmartWatch, a tablet, a cellular modem, etc., and typically any device that can connect to a base station and establish cellular communication according to any of the known or future cellular communication standards.

The system 200 comprises locating equipment 204. The locating equipment may for example be a goniometer.

The locating equipment 204 can be stationary. The locating equipment 204 can be arranged on a vehicle, and in particular in/on an aircraft.

The function of the locating equipment 204 is to analyze at least one signal emitted by a cellular device and to determine the location of said cellular device, and in particular the direction of arrival of the signal and/or the location of the cellular device.

The locating equipment 204 is in particular configured to carry out steps 116 to 120 of the method.

In a known way, to locate cellular devices that can communicate in a frequency range, the locating equipment 204 is configured to perform a temporal scan of the frequency range, by frequency bands, by listening to one frequency band at a time.

The system may further comprise a base station 206.

The base station 206 can be a conventional base station known to the skilled person.

The base station 206 can be stationary or mobile.

The base station 206 comprises a scheduler 208 whose function is to allocate one or more communication slots to each cellular device 202ᵢ wishing to connect to the base station. This communication slot or slots are determined and allocated following receipt of a communication request received from the cellular device 202ᵢ.

As mentioned hereinbefore, the communication slot(s) can be determined based on a scanning plan of the locating equipment 204. In this case, the scheduler 208 can in particular be configured to perform steps 104-108.

Alternatively, the communication slot(s) can be freely determined by the scheduler 208 it is the and locating device 204 that determines/modifies/adapts its scanning plan based on the communication slot(s) communicated thereto.

The scheduler 208 can be a hardware module, such as a processor, a chip, etc. Alternatively, the scheduler can be a software module, such as a computer program. According to another alternative, the scheduler can be a combination of at least one software module and at least one hardware module.

The base station 206 may further comprise equipment 210 for identifying the cellular device 202ᵢ based on a signal received from said cellular device at the communication slot(s) assigned thereto.

In particular, the identification equipment 210 can be configured to perform step 114 of the method 100 of FIG. 1, by way of at least one embodiment.

The identification equipment 210 can be a hardware module, such as a processor, an electronic chip, etc. Alternatively, the identification equipment 210 can be a software module, such as a computer program. According to still another alternative, the identification equipment 210 can be a combination of at least one software module and at least one hardware module.

Optionally, the system 200 may further comprise a module 212 for synchronizing the scheduler 208 with the locating equipment 204. This synchronization module 212 is optional as the scheduler 208 with the locating equipment 204 can communicate with each other to synchronize, without the intervention of such a synchronization module 212.

Of course, the one or more embodiments of the invention are not limited to the examples disclosed above.

1. A method for characterizing cellular devices capable of operating in a defined frequency range in common with a base station, the method performed for each cellular device of said cellular devices wishing to connect to said base station, said method comprising
allocating, by a scheduler of said base station to said each cellular device, at least one dedicated communication slot, each communication slot of said at least one dedicated communication slot comprising a communication time and a communication frequency;
receiving, by said base station, at said at least one dedicated communication slot that is allocated, a signal emitted by said each cellular device comprising an identifier of said each cellular device;
a temporal scan, in frequency bands, of said defined frequency range according to a scanning plan, by equipment that locate said cellular devices;
wherein said temporal scan comprises synchronization of said scanning plan and of said each communication slot so that the equipment is listening for a frequency band comprising the communication frequency of said each communication slot at the communication time of said each communication slot.

2. The method according to claim 1, wherein the equipment is slaved to the scheduler so that the frequency band observed by said equipment is determined based on the at least one dedicated communication slot that is allocated to the each cellular device.

3. The method according to claim 1, wherein the scheduler is slaved to the equipment so that the at least one dedicated communication slot is determined based on the scanning plan.

4. The method according to claim 1, further comprising locating the each cellular device to determine one or more of:
a direction of arrival of a signal emitted by said each cellular device;
a location of said each cellular device.

5. The method according to claim 1, wherein the equipment is remote from the base station, and wherein said method further comprises communication between the equipment and said base station.

6. The method according to claim 1, wherein said synchronization is implemented by a synchronization module in communication with, on one hand, the equipment and, on another hand, the scheduler.

7. A system that characterizes cellular devices that communicate with a base station in a defined frequency range, said system comprising:
said base station comprising
a scheduler, and
identification equipment; and
locating equipment;
configured to implement a method for characterizing said cellular devices capable of operating in said defined frequency range in common with said base station, the method performed for each cellular device of said cellular devices wishing to connect to said base station, said method comprising
allocating, by said scheduler of said base station to said each cellular device, at least one dedicated communication slot, each communication slot of said at least one dedicated communication slot comprising a communication time and a communication frequency;
receiving, by said base station, at said at least one dedicated communication slot that is allocated, a signal emitted by said each cellular device comprising an identifier of said each cellular device;
a temporal scan, in frequency bands, of said defined frequency range according to a scanning plan, by said locating equipment that locate said cellular devices;
wherein said temporal scan comprises synchronization of said scanning plan and of said each communication slot so that the locating equipment is listening for a frequency band comprising the communication frequency of said each communication slot at the communication time of said each communication slot.

8. The system according to claim 7, further a module for synchronizing the locating equipment and the scheduler.

9. The system according to claim 7, wherein the locating equipment is remote from the base station.

10. The system according to claim 7, wherein the locating equipment is local to the base station, and integrated into the base station.

11. The system according to claim 10, wherein the locating equipment is configured to determine a direction of one or more of arrival and a location of said each cellular device from at least one radio frequency measurement.

12. The system according to claim 7, wherein the locating equipment comprises a goniometer.

13. A base station comprising:
at least one scheduler,
at least one identification equipment; and
at least one locating equipment;
wherein said base station is configured to implement a method for characterizing cellular devices capable of operating in a defined frequency range in common with said base station, the method performed for each cellular device of said cellular devices wishing to connect to said base station, said method comprising
allocating, by a scheduler of said base station to said each cellular device, at least one dedicated communication slot, each communication slot of said at least one dedicated communication slot comprising a communication time and a communication frequency;
receiving, by said base station, at said at least one dedicated communication slot that is allocated, a signal emitted by said each cellular device comprising an identifier of said each cellular device;
a temporal scan, in frequency bands, of said defined frequency range according to a scanning plan, by said at least one locating equipment that locate said cellular devices;
wherein said temporal scan comprises synchronization of said scanning plan and of said each communication slot so that the at least one locating equipment is listening for a frequency band comprising the communication frequency of said each communication slot at the communication time of said each communication slot.
